(19) United States
(12) Patent Application Publication
(10) Pub. No.: US 2002/0054082 A1
(43) Pub. Date: May 9, 2002

(54) System and method for providing accurate geocoding of responses to location questions in a computer assisted self interview

(76) Inventor: Ronald S. Karpf, Gaithersburg, MD (US)

Correspondence Address: DICKSTEIN SHAPIRO MORIN & OSHINSKY LLP, 2101 L STREET NW, WASHINGTON, DC, 20037-1526, US

(21) Appl. No.: 09/911,626

(22) Filed: Jul. 25, 2001

Related U.S. Application Data
(63) Continuation of application No. 09/222,989, filed on Jan. 2, 1999.

(51) Int. Cl. G09G 5/00

(52) U.S. Cl. 345/738

(57) ABSTRACT

A system for providing accurate responses during the administration of a location based question of a computer assisted self interview uses a mouse or other pointing device to allow the user to point and choose a location or proximate area on the map that is responsive to the posed location question. The system allows respondents who are unable to provide accurate street addresses with a means to point at the exact or approximate location that is responsive to the question. For respondents, who because or confidentiality concerns, are unwilling to provide accurate street addresses, it provides a means to point at an area on the map that is responsive to the question with a degree of generality and comfort that they control.

### BACKGROUND OF THE INVENTION

1. Field of the Invention

This invention relates to a computer assisted self interview, and more particularly to a system and method for providing more accurate and complete geocoding of responses to questions concerning location that are posed during the course of a computer assisted self interview.

2. Description of the Prior

Typically, responses to questions about location during the course of a survey or interview are inaccurate and have high non-response rates. This is due to a multitude of reasons. For those respondents who are entirely willing to provide complete answers, they frequently do not know the precise address that would be responsive to the question. If they do know the address there is a high likelihood of error and misspelling when providing the response. During interviews that are confidential in nature, about illegal drug use for instance, respondents may feel that their confidentiality could be breached by providing complete and accurate responses to location based, and may fail to answer accurately and truthfully.

The analysis of information gathered from interviews often requires the geocoding or responses to location based questions. This is a process by which an address is validated and a precise and unique encoding of the address, usually latitude and longitude, coded for the response. A significant problem for the analysis of information gathered in interviews is that post-interview geocoding of responses is both expensive and subject to substantial and unknown error rates. Since the processing is post-interview, if an invalid address is provided in response to a location based question, there is no recourse for a dialog with the respondent to correct the information. Even misspelling in a street address, a frequent problem, which are easily correctable during the course of an interview, cannot be dealt with when geocoding is performed post-interview.

It is an object of the invention to provide a system and method that utilizes map display and geocoding software to increase the accuracy of the responses to location questions taken during the course of a computer assisted self interview, while also reducing the nonresponse rate to these questions.

It is a further object of the invention to provide a system and method that utilizes map display and geocoding software to provide a means for respondents to provide answers that indicate their approximate location when they are unsure of their precise location.

It is a further object of the invention to provide a system and method that utilizes map display and geocoding software to provide a means for a respondent in confidential interviews to respond to questions about location with a degree of generality consistent with the respondents own comfort level, thus increasing the likelihood of complete and accurate responses to locations that may be considered confidential by the respondent.

It is still a further object of the invention to provide a system and method that utilizes map display and geocoding software to reduce the error rates and cost associated with geocoding responses to location questions after the termination of the computer assisted self interview.

Additional objects, advantages and novel features of the present invention will become apparent to those skilled in the art from this disclosure, including the following detailed description, as well as by practice of the invention. While the invention is described below with reference to preferred embodiments, it should be understood that the invention is not limited thereto. Those of ordinary skill in the art having access to the teachings herein will recognize additional applications, modifications and embodiments in other fields, which are within the scope of the invention as disclosed and claimed herein and with respect to which the invention could be of significant utility.

### SUMMARY OF THE INVENTION

In accordance with the present invention, a system for assuring more accurate geocoding of responses to location questions in a computer assisted self interview is provided by the use of a computer with attached display, input devices, data storage and processing unit. The attached display is typically a computer monitor and input devices are typically a keyboard to enter addresses and a computer mouse to point and click at locations on the displayed map. The data storage is used to store data bases supporting the map display and geocoding software and the processing unit administers the computer assisted self interview, and utilizes software for map display and to geocode addresses provided by the respondent.

In response to a location based question posed during the course of a computer assisted self interview, the respondent is given a choice of either responding with an alphanumeric address, typically through the use of a keyboard, or may request a map be displayed. If the respondent chooses to enter an address, then the system attempts to immediately geocode the address. If the address is valid and can be geocoded, then the geocoded information and the address are stored and the system proceeds to the next step in the computer assisted self interview. If the address is invalid and cannot be geocoded then the location based question is again dispalyed for the respondent to either reenter an address or choose the alternate method of a map display path to respond to the question.

If the respondent chooses to respond to the question using a map, then a map is displayed on the attached computer display. The user controls the map display by zooming in or out to provide more or less detail. The user may choose to clear the map display and return to the posed question. When the user has identified an exact location that is their response to the posed location question, they point and click at the location to select it, and the selected location is indicated with a symbol on the computer display. Typically a computer mouse is used to point and click at a location.

Rather than indicate an exact location on the map the user has the option to indicate a proximate area on the map that is responsive to the question. To answer with a proximate area that is their response to a posed location based question, the user Can point and click at a location (just as they do when providing an exact location) and hold down the pointer device and move it away from the clicked selected location to indicate the proximate area. The proximate area is displayed on the screen by a circled area centered around a symbol on the computer display.

If the location or proximate area is not correctly specified the user may correct it by simply selecting a new location or proximate area, which redisplays the map on the computer display with the new response. When the user is satisfied that the selected location or proximate area is their response to the question, they indicate the acceptance of the response, and the location information is stored and the system proceeds to the next step in the computer assisted self interview.

The utility of the present invention is that it provides a method for assuring more accurate geocoding of responses to location questions posed during the course of a computer assisted self interview. Responses to location questions are immediately geocoded during the interview, and if an address is invalid, immediate interaction with the respondent is taken to ascertain a valid address. Respondents are also provided with the alternative of responding to the question by pointing and clicking at a place on a map. This alleviates their need to know an exact address, and can be immediately geocoded by the interview system. For those respondents who are unsure of the exact location, the system provides a means for them to indicate a proximate area as a response to the location based question. Also, for those respondents who for confidentiality concern are unwilling to provide an exact address, the system provides a means for them to indicate a proximate area. Thus even respondents unsure of or who are unwilling to provide an exact location, have a means to provide a response to location based questions posed during the administration of a computer assisted self interview.

### BRIEF DESCRIPTION OF THE DRAWINGS

The accompanying drawings, which are incorporated in and constitute a part of the specification, illustrate the preferred embodiment of the invention, and together with the detailed description of the preferred embodiment, serve to explain the principles of the invention.

FIG. 1 is a block diagram of a computer system used in the preferred embodiment of the invention.

FIG. 2 is an example of a location based question displayed during a computer assisted self interview.

FIG. 3 is the data elements used to record the users geocoded response to a location based question.

FIG. 4 is an example of a map displayed to a respondent of a computer assisted self interview.

FIG. 5 is an example of a map display on which the user has indicated an exact location in response to a location question.

FIG. 6 is an example of a map display on which the user has indicated a proximate area in response to a location question.

FIG. 7 is a state diagram for the processing of a location question.

FIG. 8 is a state table describing in detail the processing of a location question.

### DETAILED DESCRIPION OF THE PREFERRED EMBODIMENT

References will now be made in detail to the preferred embodiments of the invention, examples of which are illustrated in the accompanying drawings. Wherever possible, the same reference numbers will be used throughout the drawings to refer to the same or like parts.

1. Definitions

Before discussing the preferred embodiment of the invention it will be helpful to define certain terms which are used in the disclosure.

The term “Computer Assisted Self Interview” or “CASI” is used to refer to a computer based system for posing questions to a interviewee and recording their responses. A typical system might utilize a computer monitor to present the questions to the respondent, a keyboard or other type of input device for the user to respond to the questions, a comnputer mouse select and invoke on-screen buttons, and a computer program to manage the administration of the interview and record responses.

The term “Respondent” is used to refer to the person who is responding to the questions in an interview. This person is also the user of the “CASI” and the interviewee.

The term “Location Question” refers to any question during the course of a Computer Assisted Self Interview that asks the respondent to identify a place location. For example, a location question may ask for a street address, state, country, area code, etc.

The term “Location” refers to the users alphanumeric response to a location question. For instance in response to a location question asking for the address of the respondent, the user might enter their residence street address, city, state, and zip code.

The terms latitude and longitude have their usual meaning as a spatial reference system for the Earth's surface. Latitude is an angular measurement North or South of the equator, longitude is an angular measurement East or West of the meridian at Greenwich, UK.

The term “Point Location” refers to a unique point specification of a place. In the context of this invention it is completely determined by 2 numbers—the latitude, and longitude. Every place has a unique representation as a latitude and longitude. Similarly, every latitude and longitude corresponds to a precise location.

The term “Proximate Area” is a non-negative number that specifies the distance around a point location in some specific units or scale. The number specifies a radius that is drawn around a point location, thus providing a respondent with a means to respond to a location question with a degree of imprecision that can be easily quantified. The units may be in feet, yards, miles, etc.

The term “Geocode” refers to a numerical encoding of a location, and is completely specified by the Point Location and Proximate Area. For the purposes of this invention a Geocode will be defined to optionally include also, if provided, the alphanumeric location. Thus, a Geocode is an ordered 5-tuple value in which the first 2 entries are the point location of the response given by latitude and longitude; the third and fourth entries give the proximate area or circular radius around the point location and the units; and the last entry is the location or alphanumeric response. If the proximate area is specified as ‘0’ then the Geocode specifies an exact location. If the proximate area is greater than ‘0’ then the Geocode specifies a proximate area as a response to the location question.

The term “Map Display System” refers to computer code and their associated map databases that are utilized by the invention to display maps on a computer screen.

The term “Geocodeing Software” refers to computer code and the associated databases that are used by the invention to geocode an address. A geocoding system can take as input an alphanumeric description of a location, such as an address, process the input, and return a point location latitude and longitude for the location.

2. System and Method for Providing Accurate Geocoding of Responses to Location Questions in a Computer Assisted Self Interview

A. Hardware, Operating System and Applications Development Software

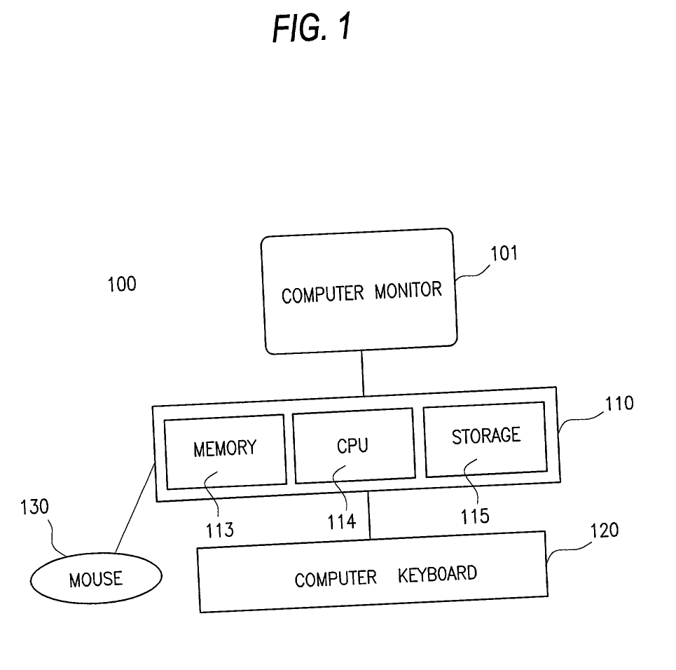

FIG. 1. is a block diagram of the computer system 100 used in the preferred embodiment of the invention. It consists of a computer monitor 101, a computer 110, a computer mouse 130, and a computer keyboard 120. The computer 110 includes a memory 113, a processor (CPU) 114, and a mass storage device 115. Monitor 101, the computer mouse 130, and computer keyboard 120, are connected to computer 110 in a manner known to persons of ordinary skill in the art.

Computer 110 preferably is a Dell OptiPlex XMT, the keyboard 120 is a Dell Quietkey, and monitor 101 a Dell Ultrascan 17XE, all manufactured by the Dell Corporation of Austin, Tex. The computer mouse 130, is a Microsoft System Mouse, manufactured by the Microsoft Corporation of Redmond, Wash.

In the preferred embodiment, computer 110 is executing under Microsoft Windows 95. The client program is written in a computer language called Microsoft Visual Basic using the Microsoft Visual Basic Version 5.0 Professional Edition. This application development tool is from the Microsoft Corporation of Redmond, Wash. The Map Display System used by the preferred embodiment is the MapX OCX Component, Version 3.5.2 from the MapInfo Corporation of Troy, N.Y. The GeoCoding System uses the MapMarker OCX Component Version 4.2 also from the MapInfo Corporation of Troy, N.Y. Other embodiments may use other hardware and software components.

B. Example of a Location Question Posed During a Computer Assisted Self Interview

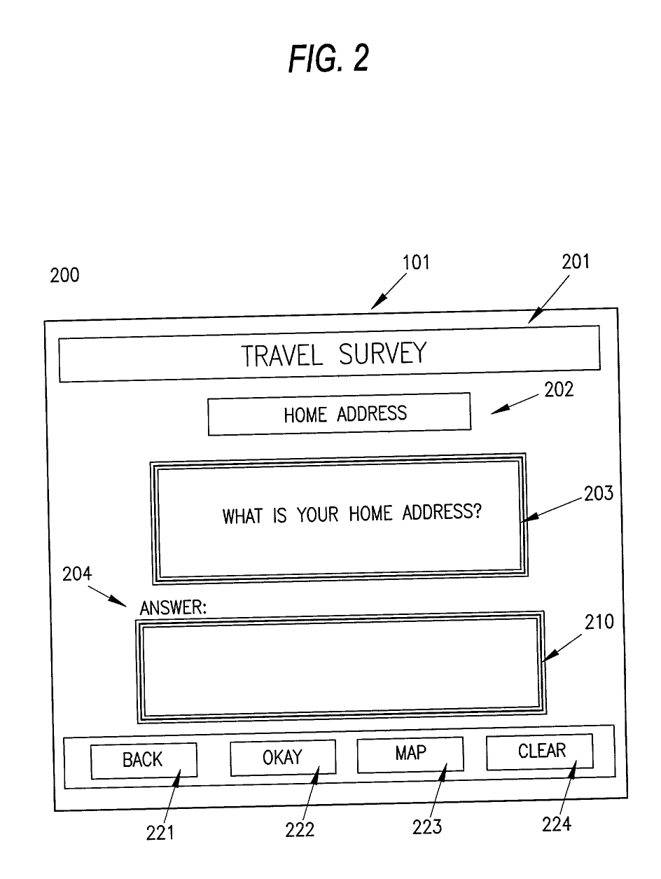

FIG. 2 is an example of a format of a location based question 200 on the display screen 101 of the computer used in the preferred embodiment of FIG. 1. In this example there are 4 label items 201, 202, 203 and 204 that describe the question for the user. The label item 201 identifies the name of the interview, in this case, ‘Travel Survey’, label item 202 is a short description of the question, in this case ‘Home Address’ since the location based question is about the respondents home address, label 203 contains the text of the question posed to the respondent, in this case the question ‘What is your home address?’, and label 204 indicates to the respondent the location of the text box where the respondent will respond to the location based question.

The textfield 210 is where the respondent will use the keyboard 120 of FIG. 1 to enter their alphanumeric response to the question.

Four buttons are provided on the screen for the user to respond to the display question. A button is activated by pointing the computer mouse 130 at the button and pressing the left mouse button. When a button is activated the computer assisted self interview responds by taking an action indicated by the label on the button. Button 221 labelled ‘BACK’ provides a means for the respondent to navigate ‘BACK’ to the previous step in the interview. Button 222, labelled ‘OKAY’ provides a means for the respondent to indicate that their response to the posed question is complete and the computer assisted self interview should proceed to the next step in the interview. In this case the action of the computer will be to (i) invoke the geocoding program to geocode the address (ii) if successful then proceed to the next question in the interview (iii) if the geocoding is not successful to clear the respondents answer from textfield 210 and redisplay the location based question 200.

Button 223, labelled ‘MAP’ provides a means for the respondent to request the display of a map which will be used to respond to the location based question. Button 224, labelled ‘CLEAR’, provides a means for the respondent to clear any keyentered response in the textfield 210.

C. Data Structure

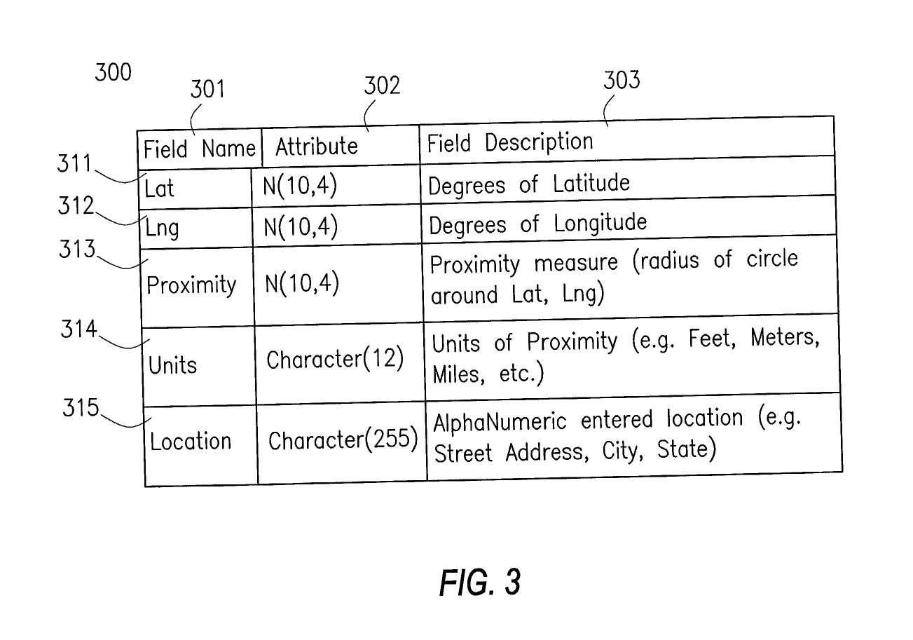

FIG. 3 shows the data structure 300 of the GeoCode that contains the response to a location based question of FIG. 2. The data structure may be saved in the computers memory 113 or on a computer storage device 115. Each item in the GeoCode is defined by an identifier ‘FieldName’ 301, attributes of the data item given by ‘Attribute’ 302, and an description given by ‘Field Description’ 303.

There are 5 fields in the GeoCode 300 that give all the information necessary to describe a GeoCode for a response to a location based question.

Field ‘Lat’ 311 provides the Latitude of the GeoCode and Field ‘Lng’ 312 provides the Longitude of the GeoCode. Each of these fields is entered in a numeric field with attribute N(10,4), of length 10 with 4 decimal points of precision. In the preferred embodiment these fields are required and must have a value derived either from use of the Geocoding software program of from the respondents selection of a place on the displayed maps.

Field ‘Proximity’ 313 is a non-negative number which gives the radius of the circle around the selected point location identified by ‘Lat’ 311 and ‘Lng’ 312, and that specifies the respondents proximity response to a location based question. The ‘Proximity’ field is entered in a numeric field with attribute N(10,4), of length 10 with 4 decimal points of precision, and will have a value of ‘0’ if the respondent provides an exact point location. The field ‘Units’ 314 provides the units for the ‘Proximity’ measure 313 and is stored in a character field 12 characters in length. Examples of possible entries in this field are ‘feet’, ‘miles’, ‘meters’, etc. The fields ‘Units’ 314 and will have no entry if the the respondent responds to the question by entering an alphanumeric address, or if the respondent uses a map but provides an exact point location response.

Field ‘Location’ 315 provides the alphanumeric typed response to the location based question and is stored in a character field of length 255. This field may be empty if the user chooses to respond to the location based question by using a map to provide a point location or proximity response. The user may also choose to provide an alphanumeric response and then request a map display by selecting button 223. In this case the fields ‘Location’ will be stored along with fields of information from the use of the map display.

D. Use of Maps to Provide More Accurate and Complete Geocoding

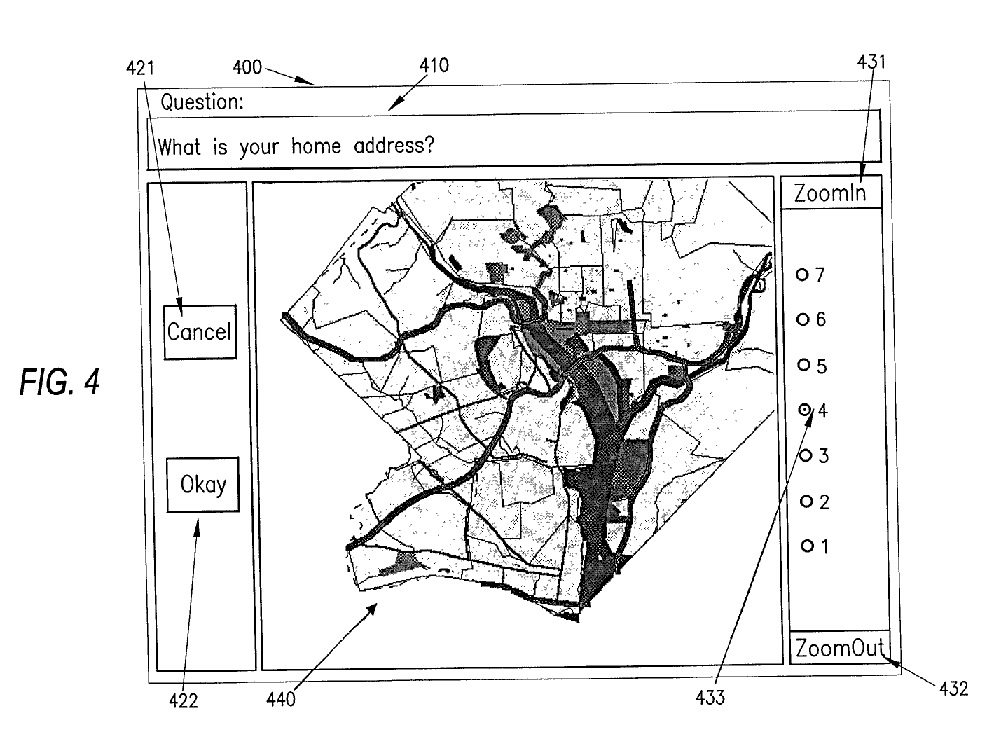

FIG. 4 is an example 400 of a map displayed to a respondent of a computer assisted self interview. The display shows the screen of the computer monitor 101 with a map 440 displayed by the map display software that will be used by the respondent to provide to the location based question. The location based question 203 that was posed to the user in the computer assisted self interview is copied and displayed to the user for reference purposes, in text box 410. In this case the question ‘What is your home address?’ has been copied from the computer assisted self interview text box 203.

The user is provided with screen buttons ‘Cancel’ 421 and ‘Okay’ 422 to move to other steps in the processing of a location based question. Either button is selected by pointing the mouse pointing device 130 at the screen button and then depressing the left mouse button. The button ‘Cancel’ 421 is used to terminate the use of maps by the respondent as a means to respond to a location based question, and processing would continue by redisplaying the location based question 200. The button ‘Okay’ 422 is used to indicate that the point location or proximity response provided by the respondent is to be used as the response to the location based question, and the Geocode of the response is to be stored and processing should continue with the next step of the computer assisted self interview.

The level of detail displayed for the user on the map is indicated by a radio buttons 433 along the right side of the map display. When the map is first displayed to the user the level of detail is set at ‘4’, as indicated by the shading of radio button ‘4’ on the map display. The contorl of map detail level is provided by the use of the buttons ‘ZoomIn’ 431 and ‘ZoomOut’ 432.

The user is provided with screen button ‘ZoomIn’ 431, and ‘ZoomOut’ 432 to increase or decrease respectively the level of detail displayed by the map. If the respondent selects the ‘ZoomIn’ button then the level of detail is increased by using the map display software to redisplay the map at a higher level of detail. The level of detail is indciated to the user by resetting the radio button 433 to a new level that is one higher than had previously been displayed. If the respondent selects the ‘ZoomOut’ button then the level of detail is decreased by using the map display software to redisplay the map at a lower level of detail. The level of detail is indicated to the user by resetting the radio button 433 to a new level that is one lower than had previously been displayed.

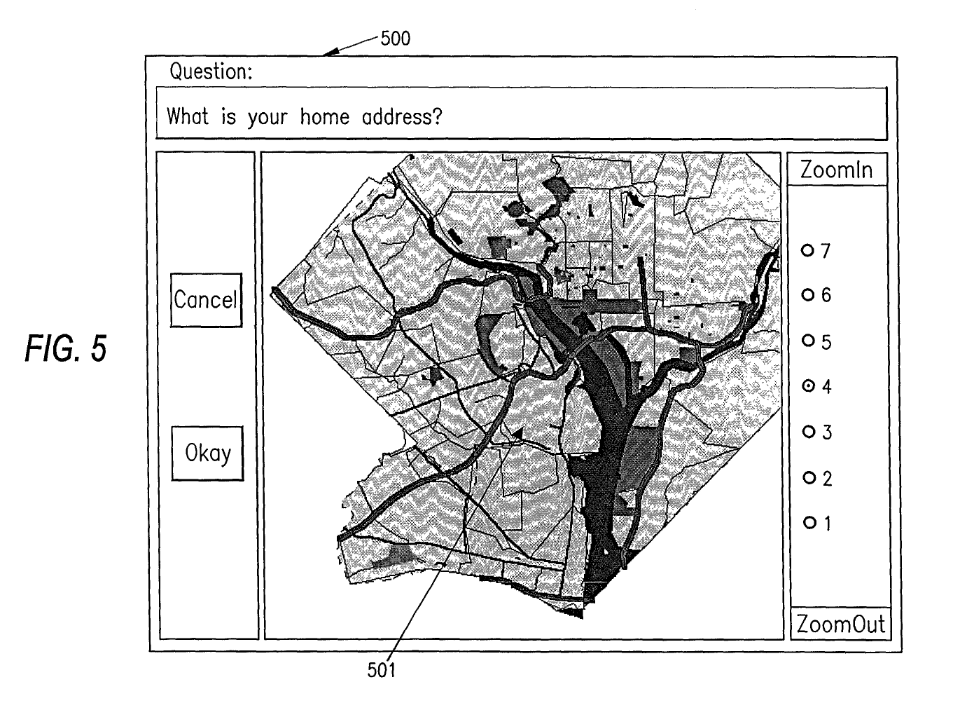

FIG. 5 is an example 500 of a map display on which the user has indicated an exact location in response to a location question. The map display is the same as that initially displayed to the respondent but also contains on the display the symbol ‘+’ 501 indicating the point location that is the response to the question ‘What is your home address?’ The point location is chosen by using the mouse pointing device 130 to point and click at a location on the screen.

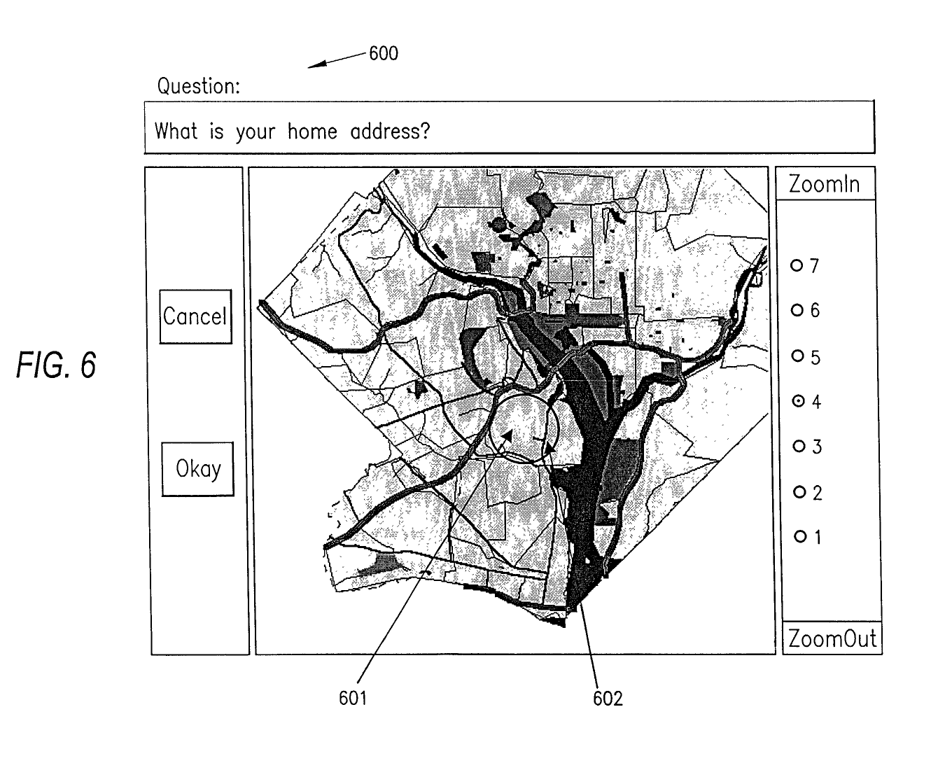

FIG. 6 is an example 600 of a map display on which the user has indicated a proximate area in response to a location question. The map display is the same as that initially displayed to the respondent but also contains on the display the symbol ‘+’ 601 and a circle 602 drawn around this symbol. The symbol ‘+’ 601 indicates the center location of the proximity region and the circle 602 indicates the proximate area response to the location question. Any geographic place within the proximate area would be considered responsive to the location based question.

E. Steps for More Accurate and Complete Geocoding

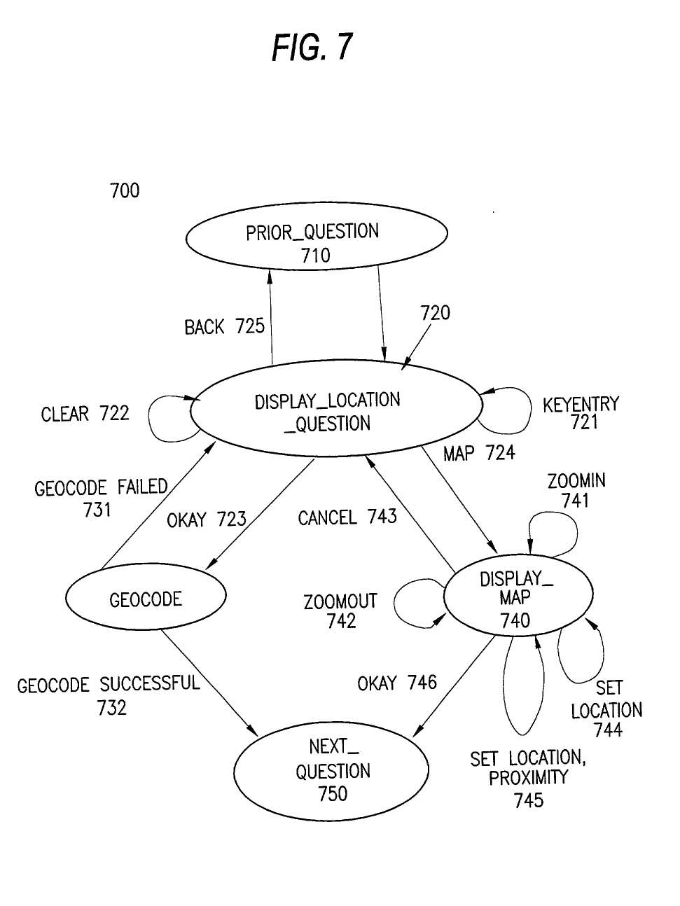

FIG. 7 is a state diagram 700 showing the state machine describing the system and method that utilizes map display and geocoding software to respond to a location based question in a computer assisted self interview. The state machine 700 has 5 states. The state ‘PRIOR_QUESTION’ 710 represents the state of the computer assisted self interview program just prior to display of a location based question.

In state ‘DISPLAY_LOCATION_QUESTION’ 720, the computer assisted self interview displays the location based question to the user and waits for a user action. The screen is displayed with an empty response field 210 of FIG. 2. If the requested action is ‘KeyEntry’ 721 then the user has typed a key on the computer keyboard input device 120, and the keyed entry is added to the alphanumeric location response and displayed in textfield 210 and processing continues by waiting for the next user action in the current state. Up to 255 characters can be added, and any keyed entries after 255 characters are ignored.

The requested user actions ‘CLEAR’722, ‘OKAY’ 723, ‘MAP’ 724, and ‘BACK’ 725 are all activated by use of the computer mouse pointing device 130, by pointing at a button on the screen and then pressing the left mouse button to activate the selected button. If the requested action is ‘CLEAR’ 722 then the user has requested that any key entered location response currently displayed in textfield 210 be cleared and redisplayed without an entry. The processing continues by clearing the location response, redisplaying the screen, and waiting on the next user action in the current state. If the requested action is ‘OKAY’ 722 then the user has finished entering their alphanumeric response to the location based question and they are ready to continue with the next step in the computer assisted self interview. Processing continues by storing the location response and transitioning to the state ‘GEOCODE’ 730. If the requested action is ‘MAP’ 724 then the user is requesting the use of a map to respond to the location based question. Processing continues by storing any location response and transitioning to the state ‘DISPLAY MAP’ 740. If the requested action is ‘BACK’ 725 then the computer assisted self interview returns to the state ‘PRIOR_QUESTION’ 710 and continues processing at the previous step of the computer assisted self interview.

In state ‘GEOCODE’ 730 the key entered alphanumeric response to a location based question is processed by invoking Geocoding software to Geocode the location response. The Geocoding will either succeed or fail. If the Geocoding is successful then the Geocode is stored and processing continues by transitioning to the state ‘NEXT_QUESTION’ 750 to continue administration of the computer assisted self interview with the next step of the interview. If the next step in the interview is another location based question then the processing described for a location based question by the current state diagram will be re-invoked. If the Geocoding fails, then the processing continues by transitioning back to the state ‘DISPLAY_LOCATION_QUESTION’ 720 to have the respondent provide a valid response to the location based question by either reentering an alphanumeric response or invoking a map.

In state ‘DISPLAY_MAP’ 740 the system utilizes map display software to display a map to the user which they will use to respond to the location based question. The user will indicate their response by use of the computer mouse pointing device 130. The mouse may be used in 2 different ways to provide a response to the location based question—by entering either a point location response or a proximity response. The respondent enters a point location response with the mouse by pointing and clicking at a location on the map displayed on the screen. The user enters a proximity response by pointing and clicking at a center location on the map displayed on the screen, keeping the mouse button depresseed, and pulling the mouse away from the center location. The proximity area will be displayed to the user by drawing on the map display a circle around the center location whose radius changes depending on the distance the mouse is moved away from the center location. When the correct proximity area is specified the user releases the left mouse button. The mouse may also be used to select buttons on the display screen to ‘ZoomIn’ 431 or ‘ZoomOut’ 432 on the map display, or to choose the actions ‘Cancel’ 421 or ‘Okay’ 422. The mouse can be used to select a screen cutton by pointing at a button and depressing the left mouse button.

Upon entering the state ‘DISPLAY_MAP” 740 the map is displayed without any indicated point location or proximity and the system waits on a user action. If the requested action is to ‘ZoomIn’ 741 then the map is redisplayed along with any point location or proximity response, by the map display software, but with more detail and processing continues in the current state by waiting on the next user action. If the requested action is ‘ZoomOut’ 742 then the map is redisplayed, along with any point location or proximity response, by the map display software, but with less detail and processing continues in the current state by waiting on the next user action. If the requested action is ‘CANCEL’ 743 then processing continues by discarding any user response to the location based question using the map display and transitioning back to the prior state ‘DISPLAY_LOCATION_QUESTION’ 720.

If the requested action is ‘SET LOCATION’ 724, then any previous point location or proximity response is discarded and the respondent is using the mouse pointing device to select a point location on the currently displayed map. This point location is marked by a symbol ‘+’ which is redisplayed along with the current map by the map display software, and processing continues in the current state by waiting for the next user action. If the requested action is ‘SET LOCATION, PROXIMITY’ 725, then any previous point location or proximity response is discarded and the respondent is using the mouse pointing device to select a proximity on the currently displayed map. This proximity is marked by a symbol ‘+’ at the center location of the proximity and by a circle drawn around the center location at a radius indicated by the respondent. The map is redisplayed along with the proximity indicators, and processing continues in the current state by waiting on the next user action.

If the requested action is ‘OKAY’ 746, then the user is affirming that the currently selected point location of proximity information is correct. The processing continues by storing the Geocoded response and transitioning to the state ‘NEXT_QUESTION’ 750. If no point location or proximity has been selected then the system remains in the current state and waits on the next user action.

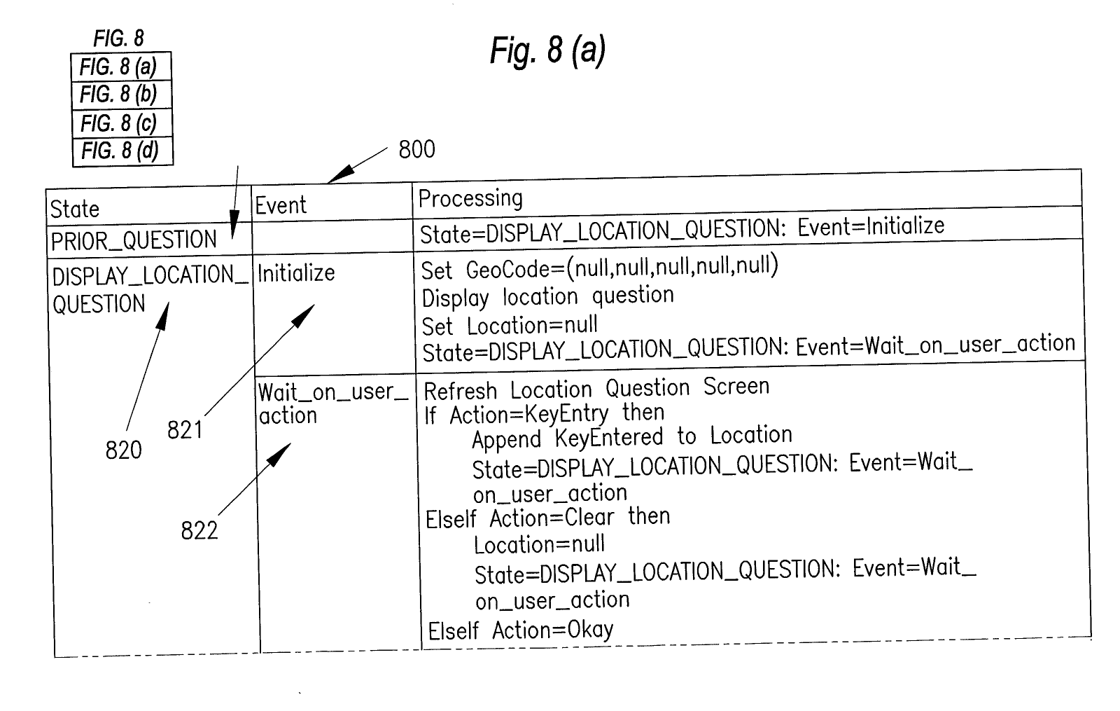

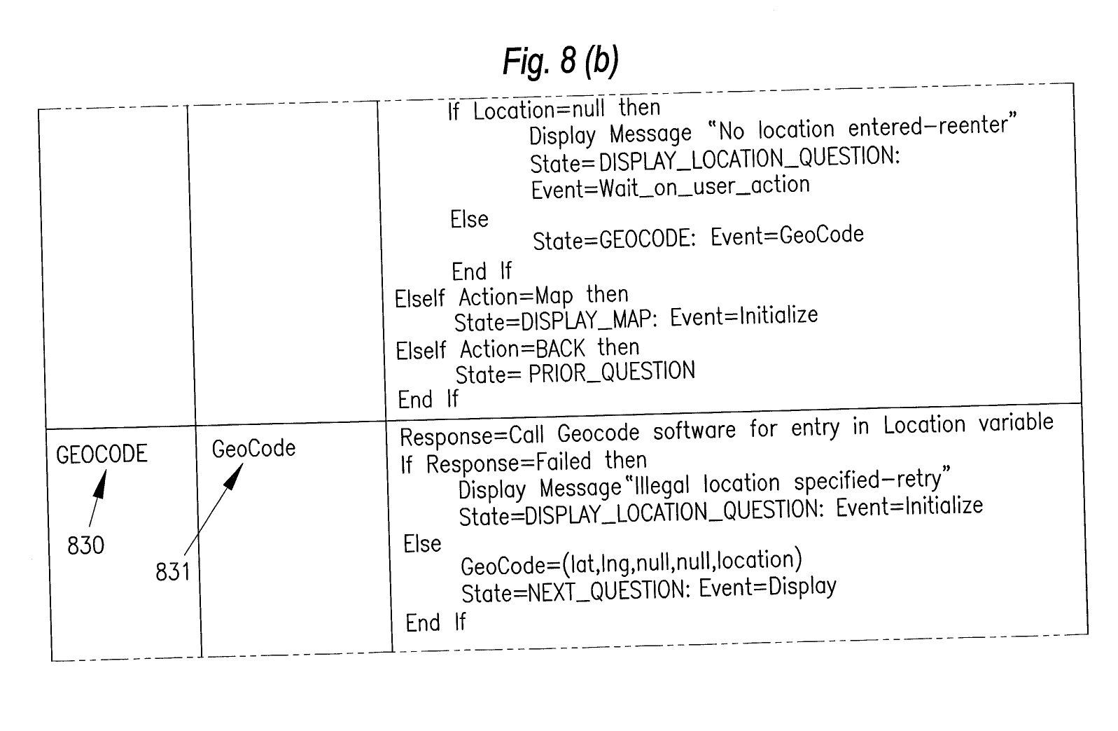

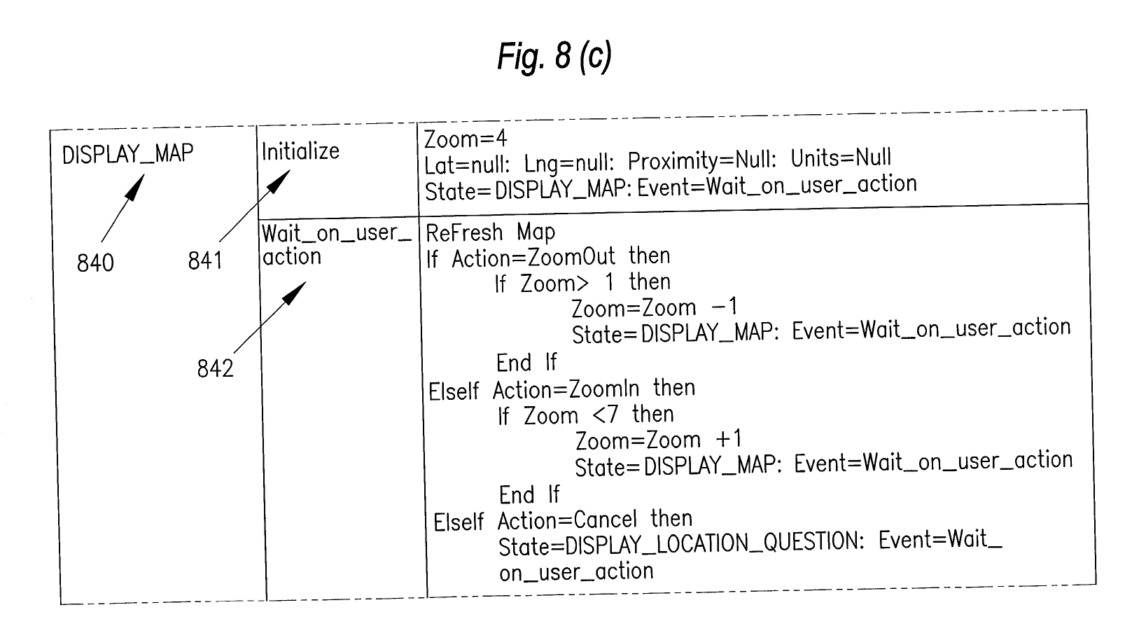

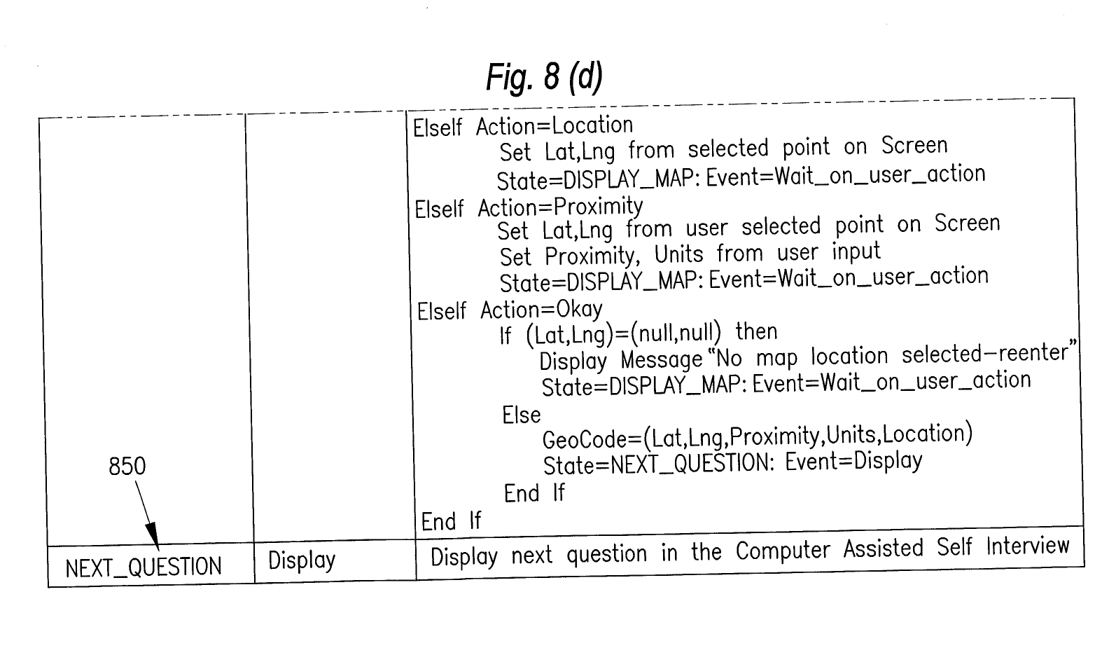

FIG. 8 is a diagram 800 with the state table describing in detail the processing of a location question.

The processing starts out at a state ‘PRIOR_QUESTION’ 800 in the computer assisted self interview, prior to asking any location based question. Upon posing any location based question the system enters state ‘DISPLAY_LOCATION_QUESTION’ 820 for processing. Immediately upon first entering this state, initialization 821 is performed in which (i) the 5-tuple memory variable that stores the geocode is set to all null values (ii) the question is displayed to the user by the computer assisted self interview computer program (iii) the memory variable that holds the alphanumeric location entered by the user is set to a null value, and (iv) processing continues in the current state but for the Event ‘Wait_on_user_action’ 822. The computer waits upon user input either in the form of input from the keyboard or mouse.

If the action is ‘KeyEntry’ then the typed keyboard entry is appended to the alphanumeric location and displayed on the screen. If the action is ‘Clear’ then the memory variable that holds the alphanumeric location is reset to a null value and the computer screen redisplayed with the initialized value.

All other responses that the user may use in this state utilize the mouse pointing device to point and click at screen buttons for further processing. If the screen button selected by the user is ‘Okay’ then the user is indicating that they have finished entering an alphanumeric location response. The system checks to see if the location is null, and if it is then it displays the message “No location entered—reenter” and processing continues in the current state. If the location is not null, then processing continues by transitioning to the state ‘GEOCODE’ 830 to geocde the alphanumeric entered response. If the screen button selected by the user is ‘MAP’ then the user has chosen to use a map to enter either a point location or a proximity location in response to a location based question of the computer assisted self interview, and processing continues by transitioning to the state ‘DISPLAY_MAP’ 840 for initialization.

In state ‘GEOCODE’ 830 processing continues by calling the Geocoding software to attempt to geocode the response stored in the location memory variable. The geocoding software will either succeed or fail at geocoding the alphanumeric address. If the response of the geocoding software is ‘Failed’ then the system displays the message ‘Illegal location specified—retry’, and processing continues by transitioning to the state ‘DISPLAY_LOCATION_QUESTION’ 830 for re-initializtation. If the geocoding software succeeds in geocoding the user typed location, then processing continues by (i) accessing the latitude and longitude of the geocoded address (ii) storing the Geocode as (lat, lng, null, null, location) (iii) transitioning to the state ‘NEXT_QUESTION’ 850 to continue with the next step in the computer assisted self interview.

Upon first entering the state ‘DISPLAY_MAP’ 840 initialiation is performed by (i) setting the detail level of the map (Zoom=4) (ii) invoking the map display software to display the map on the computer screen for the user (iii) setting the memory variables Lat, Lng, Proximity, and Units to null, and then (iv) continuing processing in the current state but for the event ‘Wait_on_user_action’ 842. The first step is to redisplay the map and point or proximity location using the map display software. The computer then waits upon user input from the computer mouse to either invoke processing by selecting a screen button or by pointing, clicking and dragging the mouse to indicate a point or proximity location response.

If the user selects the screen button ‘ZoomOut’ then check to see if the map detail level specified in the ‘Zoom’ memory variable is greater than ‘1’. If it is then decrement the ‘Zoom’ memory variable by ‘1’ and redisplay the map, using the map display software at the next lower level of detail. If the ‘Zoom’ memory variable is ‘1’ then the system cannot ‘ZoomOut’ on any more detail. Processing continues in the current state by waiting on the next user action.

If the user selects the screen button ‘ZoomIn’ then check to see if the map detail level specified in the ‘Zoom’ memory variable is less than ‘7’. If it is then increment the ‘Zoom’ memory variable by ‘1 and redisplay the map, using the map display software at the next higer level of detail. If the ‘Zoom’ memory variable is ‘7’ then the system cannot ‘ZoomIn’ on any more detail. Processing continues in the current state by waiting on the next user action.

If the user select the screen button “Cancel’ then they have decided not to respond to the location based question using a mapping method. Processing continues by transitioning back to the state ‘DISPLAY_LOCATION_QUESTION’ 820 and event ‘Wait_on_user_action’ 822, using any previously entered alphanumeric location information stored in the location memory variable when redisplaying the question on the computer monitor.

If the user selects the screen button ‘Okay’ then they have decided that the point or proximity location response is accurate and are ready to move to the next step in the computer assisted self interview. Processing continues by first checking to see if they have entered a response by checking to see if the ‘Lat’ and ‘Lng’ memory variables are both not null. If they are both null then display the message ‘No map location selected—reenter’ and continue processing in the current state. If ‘Lat’ and ‘Lng’ are not null then processing continues by (i) calculating the latitude and longitude of the map location from the map display software (ii) storing the Geocode as (lat, lng, null, null, location) (iii) transitioning to the state ‘NEXT_QUESTION’ 850 to continue with the next step in the computer assisted self interview.

The user may use the computer mouse device to provide a point or proximity location response. If the user points and clicks the mouse at the map then they are selecting a point location as their response. The system uses the map display software to calculate the latitude and longitude and stores the values in the ‘Lat’ and ‘Lng’ memory variables. Processing continues in the current state.

If the user points, clicks and drags the mouse on the map then they are selecting a proximity as their response. The system uses the map display software to calculate the latitude, longitude, proximity and units measures, and stores the values in the ‘Lat’, ‘Lng’, ‘Proximity’, and ‘Units’ memory variables. Processing continues in the current state.

Note that after any of these user actions, processing continues by redisplaying the map and any user selected location or proximity reponse.

3. Other Embodiments

Other embodiments of the invention use the same principles to achieve the goal of acquiring more accurate geocoding of responses to location based questions during the administration of a computer assisted self interview. In the preferred embodiment the respondent must provide a response to a location based question. In other embodiments, the respondent would be allowed to refuse to answer or otherwise not respond to a location question. In the preferred embodiment the user may indicate a level of imprecision in their response by providing a proximite area to their response. In other embodiments it may be advantageous to force the user to provide only a point location. In such an embodiment of the invention there would be no means to provide a proximate area as a response to a location based questin. In still other embodiments, other means may be employed to provide proximate area such as elliptical, rectangular, irregular areas, or geographic areas such as counties or census tracts.

Other embodiments will be apparent to those skilled in the art from consideration of the specification and practice of the invention disclosed herein. It is intended that the specification and examples be considered as exemplary only, with a true scope of the invention being indicated by the following

What is claimed is:

1. A system for providing accurate location responses during the administration of a computer assisted self interview comprising:
Means to display a location based question to a respondent;
Means for the respondent to answer the location based question by either entering an alphanumeric response or requesting display of a map;
A processing unit to geocode a response to a location based question
Means to display a map to a respondent of a computer assisted self interview;
Means to select a point location on the displayed map in response to the location based question;
Means to select a point location and proximity on the displayed map in response to the location based question;
Means to record the response to a location based question.

2. A system according to claim 1, wherein:
Said means to display a location based question includes a computer monitor or other computer output device.

3. A system according to claim 1, wherein:
Said means for a respondent to answer a location based question includes at least one of a keyboard, touchscreen, or pointing device such as a mouse.

4. A system according to claim 1, wherein:
Said means to geocode a response to a location based question by (i) attempting to geocode the location entered by the user in response to the location based question (ii) if the response cannot be successfully geocoded then redisplaying the location based question to the user (iii) if the response is successfully geocoded then continuing on to the next step in the computer assisted self interview.

5. A system according to claim 1, wherein:
Said means to display a map includes a computer monitor or other computer output device;
Said map can be redisplayed by zooming in or out on the map to provide more or less detail for the map display.

6. A system according to claim 1, wherein:
Said means to select a point location on the displayed map in response to a location based question includes at least one computer input devices such as a keyboard, touchscreen, or pointing devices such as a mouse;
Said means to select a point location on the displayed map is by; (i) using the computer input device to point and select a place on the displayed map (ii) evaluating and storing the geocode of the selected location; (iii) continuing on to the next step in the computer assisted self interview.

7. A system according to claim 1, wherein:
Said means to select a point location and proximity on the displayed map in response to a location based question includes at least one computer input device such as a keyboard, touchscreen, or pointing devices such as a mouse;
Said means to select a point location and proximity on the displayed map is by; (i) using the computer input device to point and select a point location and proximity on the displayed map (ii) evaluating and storing the geocode of the selected point location and proximity measure (iii) continuing on to the next step in the computer assisted self interview.

8. A system according to claim 1, wherein:
Said means to record the response to a location based question includes at least one of saving the response to computer memory or on a computer storage device;
Said means to record the response includes saving some or all of the alphanumeric entered location, latitude and longitude of the selected point location, and numeric value and units of the proximity measure.

9. A method for providing accurate location responses during the administration of a computer assisted self interview comprising the steps of:
Displaying a location based question to the respondent in the computer assisted self interview;
Processing a response to the location based question;
For an alphanumeric response to the location based question, geocoding the response and continuing with the next step in the computer assisted self interview, if the geocoding is successful, or redisplaying the location based question if the geocoding is not successful;
Displaying a map for the respondent to use in responding to the question;
Redisplaying the map by zooming in and out to provide more or less detail for the map display;
Processing and storing the point location and proximity measure for a place on the map selected by the user and continuing with the next step in the computer assisted self interview.
